(19) United States
(12) Patent Application Publication
(10) Pub. No.: US 2026/0211085 A1
(43) Pub. Date: Jul. 23, 2026

(54) Optical Ranging Device with Image Stabilization Function

(71) Applicant: Asia Optical Co., Inc., Taichung (TW)

(72) Inventors: Fang-Li Ma, ShenZhen City (CN); Hua-Tang Liu, Taichung (TW); Jiang-Lin Liu, ShenZhen City (CN); Yue-Ye Chen, ShenZhen City (CN); Sheng Luo, ShenZhen City (CN); Ting-Rung Hsu, Taichung (TW)

(21) Appl. No.: 19/442,074

(22) Filed: Jan. 7, 2026

(30) Foreign Application Priority Data
Jan. 21, 2025 (CN) 202510096313.X

(51) Int. Cl. G01S 7/481; G01S 17/08; G02B 23/10; G02B 27/64

(52) U.S. Cl. CPC G01S 7/4814; G01S 7/4816; G01S 17/08; G02B 23/105; G02B 27/646

(57) ABSTRACT

An optical ranging device for measuring a distance of an object is provided wherein a transmitting assembly transmits a measurement beam, the measurement beam travels to the object and is reflected by the object to form a reflection beam, a receiving assembly receives the reflection beam. A first image stabilization module includes a first lens and a first compensation assembly. A limiting mechanism is coupled to the first compensation assembly for restricting a travel distance of the first lens. A control module is electrically connected to the first compensation assembly so that a first optical axis of the first lens is moved within the travel distance restricted by the limiting mechanism or is fixed in a central position. The first compensation assembly includes a driving element and a limiting element. The driving element is configured for driving the limiting element to move within a stroke.

### BACKGROUND OF THE INVENTION

### Field of the Invention

The invention relates to an optical device with image stabilization function, and more particularly to an optical ranging device with image stabilization function.

### Description of the Related Art

A conventional laser ranging device includes a transmitting assembly, a receiving assembly, and a sight. In operation, the user aims the sight at a distant object which is to be measured, and a laser beam is emitted by the transmitting assembly, reaches the measured object, is reflected by the measured object, and is received by the receiving assembly, thereby obtaining the distance of the measured object.

However, the user may fail to keep the sight aiming at the distant object throughout the operation due to shaking of hands. That is, the laser beam may fail to be accurately projected to the measured object so that the distance measurement is inaccurate. Slight hand shaking can easily cause the laser beam to deviate from the measured object, especially when the object is far away.

### BRIEF SUMMARY OF THE INVENTION

The invention therefore provides an optical ranging device with image stabilization function that solves the problem of inaccurate distance measurement in a conventional laser ranging device due to hand shaking.

The optical ranging device in accordance with an exemplary embodiment of the invention is provided with image stabilization function for measuring a distance of an object. The optical ranging device includes a transmitting assembly, a receiving assembly, a first image stabilization module, a limiting mechanism, a motion sensor, a control module, and a second image stabilization module. The transmitting assembly is configured to transmit a measurement beam wherein the measurement beam travels to the object and is reflected by the object to form a reflection beam. The receiving assembly is configured to receive the reflection beam. The first image stabilization module includes a first lens and a first compensation assembly wherein the first image stabilization module is disposed corresponding to the transmitting assembly, the first lens includes a first optical axis, the measurement beam passes through the first lens, and the first compensation assembly is configured for driving the first lens to move with respect to the transmitting assembly or to be fixed in a first central position. The limiting mechanism is coupled to the first compensation assembly for restricting a travel distance of the first lens. The control module is electrically connected to the first compensation assembly and the motion sensor, and configured to control the first compensation assembly based on a detection of the motion sensor so that the first optical axis of the first lens is moved within the travel distance restricted by the limiting mechanism or is fixed in the first central position. The second image stabilization module includes a second lens and a second compensation assembly wherein the second image stabilization module is disposed corresponding to the receiving assembly, the second lens has a second optical axis, the reflection beam passes through the second lens, the second compensation assembly is configured for driving the second lens to move with respect to the receiving assembly or to be fixed in a second central position. The limiting mechanism is further coupled to the second compensation assembly for restricting a travel distance of the second lens. The control module is further configured to control the second compensation assembly based on a detection of the motion sensor so that the second optical axis of the second lens is synchronously moved along with the first optical axis of the first lens within the travel distance restricted by the limiting mechanism or is fixed in the second central position. The first compensation assembly includes a driving element and a limiting element, and the driving element is configured for driving the limiting element to move within a stroke.

In another exemplary embodiment, the optical ranging device further includes a telescope assembly. The telescope assembly includes an objective lens end, an eyepiece lens end and a telescope optical axis. The telescope assembly is disposed corresponding to the transmitting assembly. The telescope optical axis and the first optical axis coincide. The measurement beam passes through the telescope assembly and the first lens and reaches the object. The first compensation assembly drives the first lens to move with respect to the telescope assembly so that light emitted from the object can enters the telescope assembly and keeps forming images on the eyepiece lens end.

In yet another exemplary embodiment, the optical ranging device further includes a telescope assembly. The telescope assembly includes an objective lens end, an eyepiece lens end and a telescope optical axis. The telescope assembly is disposed corresponding to the receiving assembly. The telescope optical axis and the second optical axis overlap. The reflection beam passes through the second lens and the telescope assembly and reaches the receiving assembly. The second compensation assembly drives the second lens to move with respect to the telescope assembly so that light emitted from the object can enters the telescope assembly and keeps forming images on the eyepiece lens end.

In another exemplary embodiment, the optical ranging device further includes a telescope assembly and a third image stabilization assembly. The telescope assembly includes an objective lens end, an eyepiece lens end and a telescope optical axis. The third image stabilization assembly includes a third lens and a third compensation assembly. The third lens includes a third optical axis. The telescope optical axis and the third optical axis coincide. The third compensation assembly drives the third lens to move with respect to the telescope assembly so that light emitted from the object can enters the telescope assembly and keeps forming images on the eyepiece lens end.

In yet another exemplary embodiment, the first lens is disposed on a first sectional plane which is perpendicular to the first optical axis. The second lens is disposed on a second sectional plane which is perpendicular to the second optical axis. The third lens is disposed on a third sectional plane which is perpendicular to the third optical axis. The third sectional plane is parallel to the first sectional plane and the second sectional plane.

In another exemplary embodiment, the third compensation assembly is electrically connected to the control module. The control module is configured to control the third compensation assembly so that the third optical axis of the third lens, the first optical axis of the first lens, and the second optical axis of the second lens are moved synchronously.

In yet another exemplary embodiment, an allowable error for synchronous movement of the first optical axis, the second optical axis and the third optical axis is ±0.1 degrees.

In another exemplary embodiment, the first compensation assembly further includes a base, a movable platform, a first coil and a first magnet. The movable platform is movably disposed on the base. The first lens is disposed on the movable platform. The first coil is disposed on the base and is electrically connected to the control module. The first magnet is disposed on the movable platform. The first coil and the first magnet generate an electromagnetic interaction therebetween so that the movable platform is moved on the base in a first direction. The first compensation assembly satisfies any one of the following conditions or any combination thereof: 0.25≤(ξmax/(φ2max−φ4))≤0.5; 0.475≤(ξmin/(φ2min−φ3))≤0.525; 0.5≤(φ3/φ1)≤0.7; 0.65≤(φ3/φ2max)≤0.75; 0.495≤ξmax/(φ2max−φ2min)≤0.55, where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

In yet another exemplary embodiment, the first compensation assembly further includes a second coil, a second magnet, a first position sensor and a second position sensor. The second coil is disposed on the base. The second magnet is disposed on the movable platform. The second coil and the second magnet generate an electromagnetic interaction therebetween so that the movable platform is moved on the base in a second direction. The second direction is orthogonal to the first direction. The second coil is electrically connected to the control module. The first optical axis is perpendicular to the first direction and the second direction. The first position sensor and the second position sensor are electrically connected to the control module. The control module controls a current flowing through the first coil and/or the second coil based on a position of the first magnet detected by the first position sensor and/or a position of the second magnet detected by the second position sensor.

In another exemplary embodiment, the limiting mechanism restricts the movable platform to have the same range of travel in both the first and second directions.

In yet another exemplary embodiment, the limiting mechanism includes a first limiting module. The first limiting module includes a first limiting pin, a second limiting pin, a first limiting hole and a second limiting hole. The first limiting pin and the second limiting pin are disposed on the movable platform. The first limiting hole and the second limiting hole are formed on the base. The first limiting pin is propped against an inner wall of the first limiting hole thereby limiting movement of the movable platform in the first direction. The second limiting pin is propped against an inner wall of the second limiting hole thereby limiting movement of the movable platform in the second direction.

In another exemplary embodiment, the limiting element is disposed on the base. The stroke is a travel distance of the limiting element from a locking position to a releasing position. The limiting element is propped against the movable platform to fix the movable platform at a center of the movable platform, when the limiting element is moved to the locking position. The limiting element is separated from the movable platform and the movable platform is movable with respect to the base, when the limiting element is moved to the releasing position.

In yet another exemplary embodiment, the optical ranging device includes a transmitting assembly, a receiving assembly, a first image stabilization module, a limiting mechanism, a motion sensor, a control module, and a second image stabilization module. The transmitting assembly configured to transmit a measurement beam wherein the measurement beam travels to the object and is reflected by the object to form a reflection beam. The receiving assembly is configured to receive the reflection beam. The first image stabilization module includes a first lens and a first compensation assembly wherein the first image stabilization module is disposed corresponding to the transmitting assembly, the first lens includes a first optical axis, the measurement beam passes through the first lens, and the first compensation assembly is configured for driving the first lens to move with respect to the transmitting assembly or to be fixed in a first central position. The limiting mechanism is coupled to the first compensation assembly for restricting a travel distance of the first lens. The control module electrically is connected to the first compensation assembly and the motion sensor, and configured to control the first compensation assembly based on a detection of the motion sensor so that the first optical axis of the first lens is moved within the travel distance restricted by the limiting mechanism or is fixed in the first central position. The second image stabilization module includes a second lens. The first compensation assembly includes a driving element and a limiting element, and the driving element is configured for driving the limiting element to move within a stroke. The first optical axis of the first lens and the second optical axis of the second lens are moved at the same speed. The first lens is disposed on a first sectional plane which is perpendicular to the first optical axis. The second lens is disposed on a second sectional plane which is perpendicular to the second optical axis. The first sectional plane is parallel to or coincides with the second sectional plane.

In another exemplary embodiment, the first compensation assembly further includes a base, a movable platform, a first coil and a first magnet. The movable platform is movably disposed on the base. The first lens is disposed on the movable platform. The first coil is disposed on the base and is electrically connected to the control module. The first magnet is disposed on the movable platform. The first coil and the first magnet generate an electromagnetic interaction therebetween so that the movable platform is moved on the base in a first direction. The first compensation assembly satisfies any one of the following conditions or any combination thereof: 0.25≤(ξmax/(φ2max−φ4))≤0.5; 0.475≤(ξmin/(φ2min−φ3))≤0.525; 0.5≤(φ3/φ1)≤0.7; 0.65≤(φ3/φ2max)≤0.75; 0.495≤ξmax/(φ2max−φ2min)≤0.55, where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

In yet another exemplary embodiment, the first compensation assembly further includes a second coil, a second magnet, a first position sensor and a second position sensor. The second coil is disposed on the base. The second magnet is disposed on the movable platform. The second coil and the second magnet generate an electromagnetic interaction therebetween so that the movable platform is moved on the base in a second direction. The second direction is orthogonal to the first direction. The second coil is electrically connected to the control module. The first optical axis is perpendicular to the first direction and the second direction. The first position sensor and the second position sensor are electrically connected to the control module. The control module controls a current flowing through the first coil and/or the second coil based on a position of the first magnet detected by the first position sensor and/or a position of the second magnet detected by the second position sensor.

In another exemplary embodiment, the limiting mechanism restricts the movable platform to have the same range of travel in both the first and second directions.

In yet another exemplary embodiment, the limiting mechanism includes a first limiting module. The first limiting module includes a first limiting pin, a second limiting pin, a first limiting hole and a second limiting hole. The first limiting pin and the second limiting pin are disposed on the movable platform. The first limiting hole and the second limiting hole are formed on the base. The first limiting pin is propped against an inner wall of the first limiting hole thereby limiting movement of the movable platform in the first direction. The second limiting pin is propped against an inner wall of the second limiting hole thereby limiting movement of the movable platform in the second direction.

In another exemplary embodiment, the limiting element is disposed on the base. The stroke is a travel distance of the limiting element from a locking position to a releasing position. The limiting element is propped against the movable platform to fix the movable platform at a center of the movable platform, when the limiting element is moved to the locking position. The limiting element is separated from the movable platform and the movable platform is movable with respect to the base, when the limiting element is moved to the releasing position.

In yet another exemplary embodiment, the optical ranging device includes a transmitting assembly, a receiving assembly, a first image stabilization module, a limiting mechanism, a motion sensor, and a control module. The transmitting assembly is configured to transmit a measurement beam wherein the measurement beam travels to the object and is reflected by the object to form a reflection beam. The receiving assembly is configured to receive the reflection beam. The first image stabilization module includes a first lens and a first compensation assembly wherein the first image stabilization module is disposed corresponding to the transmitting assembly, the first lens includes a first optical axis, the measurement beam passes through the first lens, and the first compensation assembly is configured for driving the first lens to move with respect to the transmitting assembly or to be fixed in a first central position. The limiting mechanism is coupled to the first compensation assembly for restricting a travel distance of the first lens. The control module is electrically connected to the first compensation assembly and the motion sensor, and configured to control the first compensation assembly based on a detection of the motion sensor so that the first optical axis of the first lens is moved within the travel distance restricted by the limiting mechanism or is fixed in the first central position. The first compensation assembly includes a driving element, a limiting element, a base, a movable platform, a first coil and a first magnet. The driving element is configured for driving the limiting element to move within a stroke. The movable platform is movably disposed on the base. The first lens is disposed on the movable platform. The first coil is disposed on the base and is electrically connected to the control module. The first magnet is disposed on the movable platform. The first coil and the first magnet generate an electromagnetic interaction therebetween so that the movable platform is moved on the base in a first direction. The first compensation assembly satisfies any one of the following conditions or any combination thereof: 0.25≤(ξmax/(φ2max−φ4))≤0.5; 0.475≤(ξmin/(φ2min−φ3))≤0.525; 0.5≤(φ3/φ1)≤0.7; 0.65≤(φ3/φ2max)≤0.75; 0.495≤ξmax/(φ2max−φ2min)≤0.55, where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

In another exemplary embodiment, the first compensation assembly further satisfies any one of the following conditions or any combination thereof. 9.25 mm≤φ1≤11.9 mm; 6.5 mm≤φ2≤8.9 mm; 4.2 mm≤φ3≤6.4 mm; 0.05 mm≤ξ≤1.25 mm.

The optical ranging device of the invention is provided with a first image stabilization module corresponding to the transmitting assembly and a second image stabilization module corresponding to the receiving assembly. When the user performs the ranging operation, in response to slight hand shaking, the first image stabilization module compensates for the movement of the optical path of the measurement beam of the transmitting assembly, and the second image stabilization module simultaneously compensates for the movement of the optical path of the reflection beam. By such arrangement, the measurement beam can be accurately projected to the measured object, and the reflection beam can be accurately received by the receiving assembly, thus capable of compensating for the hand shaking and accurately measuring the distance.

### BRIEF DESCRIPTION OF THE DRAWINGS

FIG. 1 is a schematic view showing the arrangement of an optical ranging device with image stabilization function in accordance with a first embodiment of the invention.

FIG. 2 is a schematic view showing the arrangement of an optical ranging device with image stabilization function in accordance with a second embodiment of the invention.

FIG. 3 is a schematic view showing the arrangement of an optical ranging device with image stabilization function in accordance with a third embodiment of the invention.

FIG. 4 is a perspective view of a first compensation assembly of a first image stabilization module provided in an optical ranging device with image stabilization function in accordance with an embodiment of the invention.

FIG. 5 is a perspective exploded view of the first compensation assembly of the first image stabilization module of FIG. 4.

FIG. 6 depicts the first compensation assembly of FIG. 5 at a different view angle, showing the limiting mechanism therein.

FIG. 7 is a top view of the base of the first compensation assembly of FIG. 6.

FIG. 8 is a bottom view of the movable platform of the first compensation assembly of FIG. 6.

FIG. 9 is a top view of the first compensation assembly with the upper cover removed, showing the limiting element in a locking position (the right) and in a releasing position (the left).

### DETAILED DESCRIPTION OF THE INVENTION

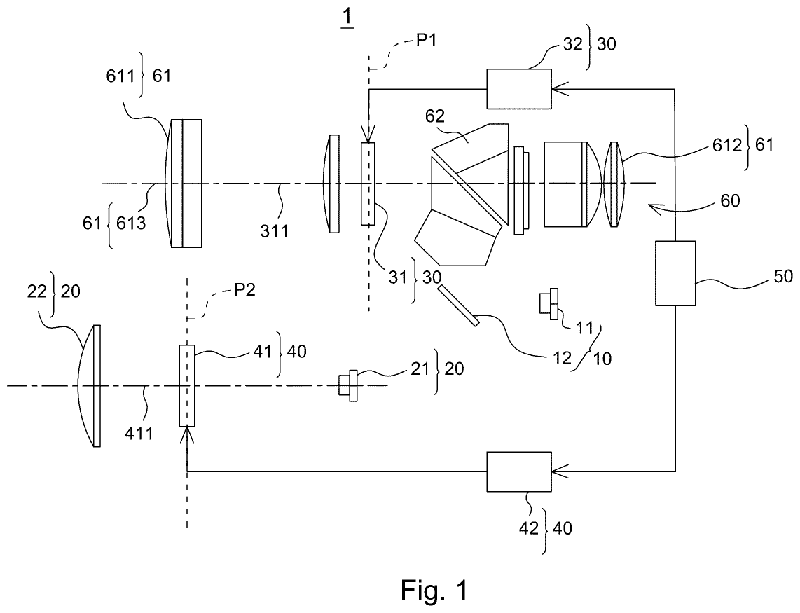

FIG. 1 depicts an optical ranging device with image stabilization function in accordance with a first embodiment of the invention, wherein the optical ranging device 1 includes a transmitting assembly 10, a receiving assembly 20, a first image stabilization module 30, a second image stabilization module 40, a control module 50 and a telescope assembly 60.

In this embodiment, the transmitting assembly 10 is integrated with the telescope assembly 60. The transmitting assembly 10 includes a light source 11 and a reflector 12. The telescope assembly 60 includes a lens group 61 and a prism 62. The lens group 61 includes an objective lens end 611, an eyepiece lens end 612, and a telescopic optical axis 613. The objective lens end 611 is disposed toward the measured object, and the eyepiece lens end 612 is disposed close to user's eye. The prism 62 is disposed in the optical path of the lens group 61, and the reflector 12 is disposed close to the prism 62, so that the optical path of the transmitting assembly 10 and the optical path of the telescope assembly 60 coincide at the objective lens end 611. In operation, a measurement beam is emitted from the light source 11, is reflected by the reflector 12 and the prism 62, passes through the objective lens 611 of the lens group 61, and is projected onto the measured object. In this embodiment, the light source 11 may be, for example, a laser diode, and the measurement beam is a laser beam. Visible or infrared light emitted from the measured object enters the lens assembly 61 through the objective lens end 611 to form images on the eyepiece lens end 612. In this way, the user can observe and aim at the measured object through the telescope assembly 60, while the measurement beam is projected onto the measured object along the optical path of the telescope assembly 60 at the objective lens end 611.

The receiving assembly 20 includes a receiver 21 and a light receiving element 22. The measurement beam reaches the measured object, and is reflected by the measured object to form a reflection beam. The reflection beam is condensed by the light receiving element 22 and is received by the receiver 21.

The first image stabilization module 30 is provided corresponding to the transmitting assembly 10 and the telescope assembly 60. The first image stabilization module 30 includes a first lens 31 and a first compensation assembly 32. The first lens 31 is disposed within the lens group 61 of the telescope assembly 60. The first lens 31 has a first optical axis 311 which coincides with the telescope optical axis 613. Before passing through the lens group 61, the measurement beam passes through the first lens 31. The first compensation assembly 32 is configured for driving the first lens 31 to move with respect to the transmitting assembly 10. When the measurement beam is slightly deviated in response to the hand shaking, the movement of the first lens 31 can compensate for the slight deviation of the measurement beam, thereby keeping projection of the measurement beam onto the measured object. Since the first optical axis 311 coincides with the telescope optical axis 613, the optical path of visible or infrared light from the measured object can be simultaneously compensated or fine-tuned by the movement of the first lens 31, allowing the user to keep aiming at the measured object with the telescope assembly 60. The first lens element 31 may be a spherical lens, an aspheric lens, or a liquid lens.

The second image stabilization module 40 is provided corresponding to the receiving assembly 20. The second image stabilization module 40 includes a second lens 41 and a second compensation assembly 42. The second lens 41 has a second optical axis 411. The second optical axis 411 and the telescope optical axis 613 overlap. The reflection beam passes through the light receiving element 22 and the second lens 41 and is received by the receiver 21. The second compensation assembly 42 is configured for driving the second lens 41 to move with respect to the receiver 21. When the reflection beam is slightly deviated in response to the hand shaking, the movement of the second lens 41 can compensate for the slight deviation of the reflection beam, thereby keeping reflection of the measurement beam to the receiver 21. The second lens 41 may be a spherical lens, an aspheric lens, or a liquid lens.

The control module 50 is electrically connected to the first compensation assembly 32 and the second compensation assembly 42, thereby controlling the first compensation assembly 32 and the second compensation assembly 42 to drive the first lens 31 and the second lens 41 in such way that the first lens 31 and the second lens 41 are moved synchronously. That is, the first optical axis 311 of the first lens 31 and the second optical axis 411 of the second lens 41 are moved synchronously, thereby capable of simultaneously compensating and fine-tuning the optical paths of the measurement beam and the reflection beam. Such arrangement ensures that the measurement beam is accurately projected to the measured object and that the reflection beam is accurately received by the receiver 21. The control module 50 detects the hand shaking by using a motion sensor (e.g., an electronic gyroscope) installed in the optical ranging device 1, thereby controlling the first compensation assembly 32 and the second compensation assembly 42 to drive the first lens 31 and the second lens 41. Further, hand shaking (or human body vibrations) will change the incident angle of the measurement beam onto the measured object and the reflection angle of the reflection beam from the measured object, and further change the optical paths of both the measurement beam and the reflection beam. Therefore, the control module 50 is configured for controlling the first compensation assembly 32 and the second compensation assembly 42 to move the first lens 31 and the second lens 41 synchronously. Then, the optical paths of the measurement beam and the reflection beam can be fine-tuned and compensated in real time and simultaneously, ensuring that the measurement beam is accurately projected to the measured object and the reflection beam is accurately received by the receiving assembly 20. Accordingly, the ranging result of the invention is accurate.

The control module 50 controls the first compensation assembly 32 and the second compensation assembly 42 to drive the first lens 31 and the second lens 41 to move at the same speed. That is, the first compensation assembly 32 and the second compensation assembly 42 have the same sensitivity, thereby ensuring that the first optical axis 311 of the first lens 31 and the second optical axis 411 of the second lens 41 are moved synchronously. The same sensitivity refers to synchronous movement, and the allowable error for synchronous movement is ±0.1 degrees. It can be considered that the first optical axis 311 of the first lens 31 and the second optical axis 411 of the second lens 41 are moved synchronously if the difference therebetween is in the range of the allowable error. In this embodiment, the first compensation assembly 32 and the second compensation assembly 42 have the same structure. As illustrated in FIG. 1, in the telescope assembly 60, the first lens 31 of the first image stabilization module 30 is disposed on a first sectional plane P1 which is perpendicular to the first optical axis 311, and the second lens 41 of the second image stabilization module 40 is disposed on a second sectional plane P2 which is perpendicular to the second optical axis 411. The first sectional plane P1 and the second sectional plane P2 are parallel to each other. Therefore, the first lens 31 of the first image stabilization module 30 and the second lens 41 of the second image stabilization module 40 are not located on the same sectional plane which is perpendicular to both the first optical axis 311 and the second optical axis 411. In other words, the first lens 31 and the second lens 41 are not aligned, so that there is space below the prism 62 to contain suitable assembly (such as a power supply unit), which makes the overall structure simple. The structure will be introduced in the following paragraphs.

Although the transmitting assembly 10 in this embodiment is integrated with the telescope assembly 60, the invention is not limited thereto. In other embodiments, the receiving assembly 20 instead of the transmitting assembly 10 is integrated with the telescope assembly 60, wherein the reflection beam enters the lens group 61 through the objective lens end 611 of the lens group 61 of the telescope assembly 60, and reaches the receiver 21 after being reflected by the prism 62. The first image stabilization module 30 is provided corresponding to the transmitting assembly 10 for compensating and fine-tuning the optical path of the measurement beam. The second image stabilization module 40 is provided corresponding to the receiving assembly 20 and the telescope assembly 60 for compensating and fine-tuning the optical path of the reflection beam.

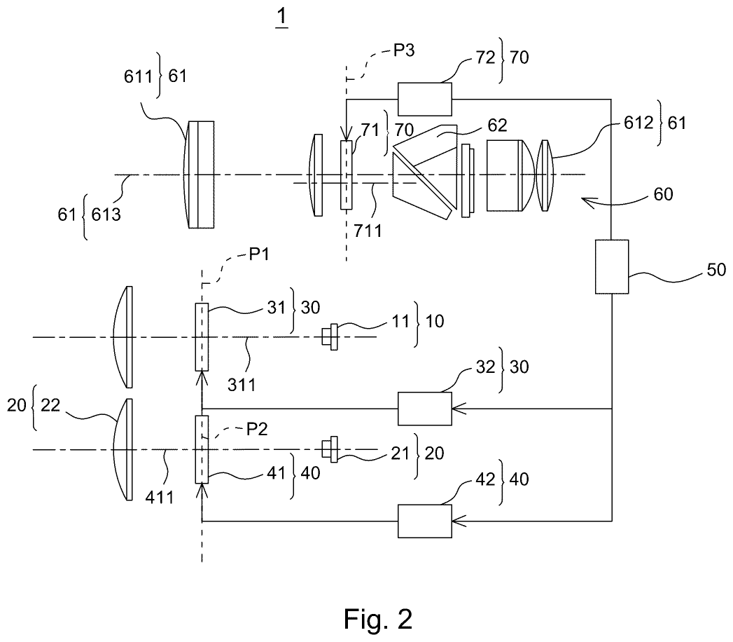

FIG. 2 depicts an optical ranging device with image stabilization function in accordance with a second embodiment of the invention, wherein the parts same as those of the first embodiment are labeled with the same reference numerals and the descriptions thereof are omitted. The second embodiment differs from the first embodiment in that the transmitting assembly 10 and the receiving assembly 20 of the second embodiment are individual parts rather than are integrated with the telescope assembly 60.

The optical ranging device 1 with an image stabilization function in accordance with the second embodiment further includes a third image stabilization module 70. The third image stabilization module 70 includes a third lens 71 and a third compensation assembly 72. The third lens 71 has a third optical axis 711. The third lens 71 is disposed in the lens group 61 of the telescope assembly 60. The third optical axis 711 of the third lens 71 and the telescopic optical axis 613 coincide. The third compensation assembly 72 is configured for driving the third lens 71 to move with respect to the telescope assembly 60 so that the visible or infrared light from the measured object can passes through the telescope assembly 60 and keep forming images on the eyepiece lens end 612. That allows the user to keep aiming at the measured object with the telescope assembly 60. The third lens element 71 may be a spherical lens, an aspheric lens, or a liquid lens.

The third compensation assembly 72 is electrically connected to the control module 50, thereby controlling the third compensation assembly 72 to drive the third lens 71 in such way that the first lens 31, the second lens 41 and the third lens 71 are moved synchronously. That is, the first optical axis 311 of the first lens 31, the second optical axis 411 of the second lens 41, and the third optical axis 711 of the third lens 71 are moved synchronously, and the first lens 31, the second lens 41 and the third lens 71 are moved at the same speed. Therefore, the first compensation assembly 32, the second compensation assembly 42 and the third compensation assembly 72 have the same sensitivity. As illustrated in FIG. 2, the first lens 31 of the first image stabilization module 30 is disposed on the first sectional plane P1 which is perpendicular to the first optical axis 311, the second lens 41 of the second image stabilization module 40 is disposed on the second sectional plane P2 which is perpendicular to the second optical axis 411, and the third lens 71 of the telescope assembly 60 is disposed on a third sectional plane P3 which is perpendicular to the third optical axis 711. The first sectional plane P1 and the second sectional plane P2 coincide. The third sectional plane P3 is parallel to the first sectional plane P1 and the second sectional plane P2. Therefore, the third lens 71 of the telescope assembly 60, the first lens 31 of the first image stabilization module 30 and the second lens 41 of the second image stabilization module 40 are not located on the same sectional plane which is perpendicular to the third optical axis 711, the first optical axis 311 and the second optical axis 411. Further, the first lens 31 of the first image stabilization module 30 and the second lens 41 of the second image stabilization module 40 are located on the same sectional plane which is perpendicular to the third optical axis 711, the first optical axis 311 and the second optical axis 411. In other words, the third lens 71 is not aligned with the first lens 31 and the second lens 41, so that there is space below the prism 62 to contain suitable assembly (such as a power supply unit), which makes the overall structure simple. The third compensation assembly 72 has the same structure as the first compensation assembly 32 and the second compensation assembly 42.

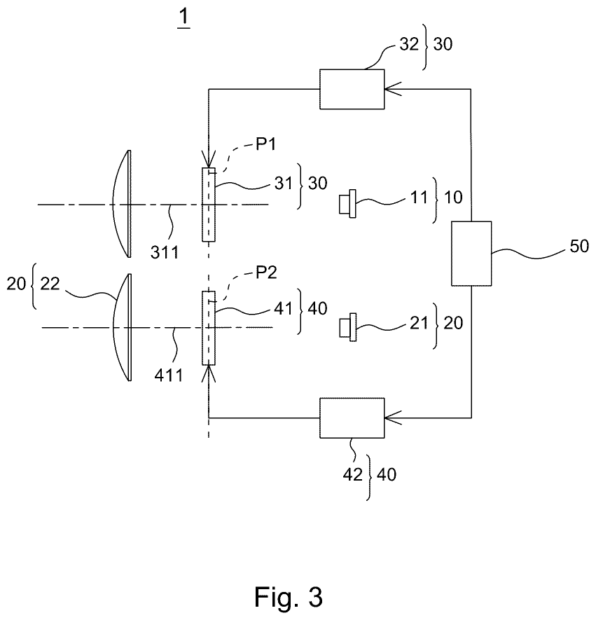

FIG. 3 depicts an optical ranging device with image stabilization function in accordance with a third embodiment of the invention, wherein the parts same as those of the second embodiment are labeled with the same reference numerals and the descriptions thereof are omitted. The third embodiment differs from the second embodiment in that the optical ranging device is provided with no telescope assembly. The transmitting assembly 10 and the receiving assembly 20 are individual parts. The first image stabilization module 30 is provided corresponding to the transmitting assembly 10. The second image stabilization module 40 is provided corresponding to the receiving assembly 20. As illustrated in FIG. 3, the first lens 31 of the first image stabilization module 30 is disposed on the first sectional plane P1 which is perpendicular to the first optical axis 311, the second lens 41 of the second image stabilization module 40 is disposed on the second sectional plane P2 which is perpendicular to the second optical axis 411, and the first sectional plane P1 and the second sectional plane P2 coincide. Therefore, the first lens 31 of the first image stabilization module 30 and the second lens 41 of the second image stabilization module 40 are located on the same sectional plane which is perpendicular to the first optical axis 311 and the second optical axis 411.

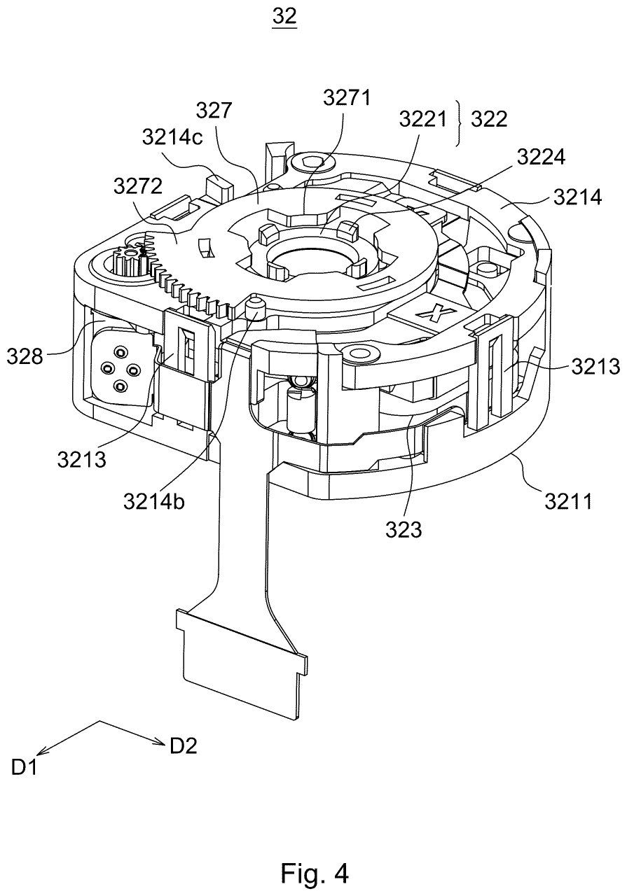

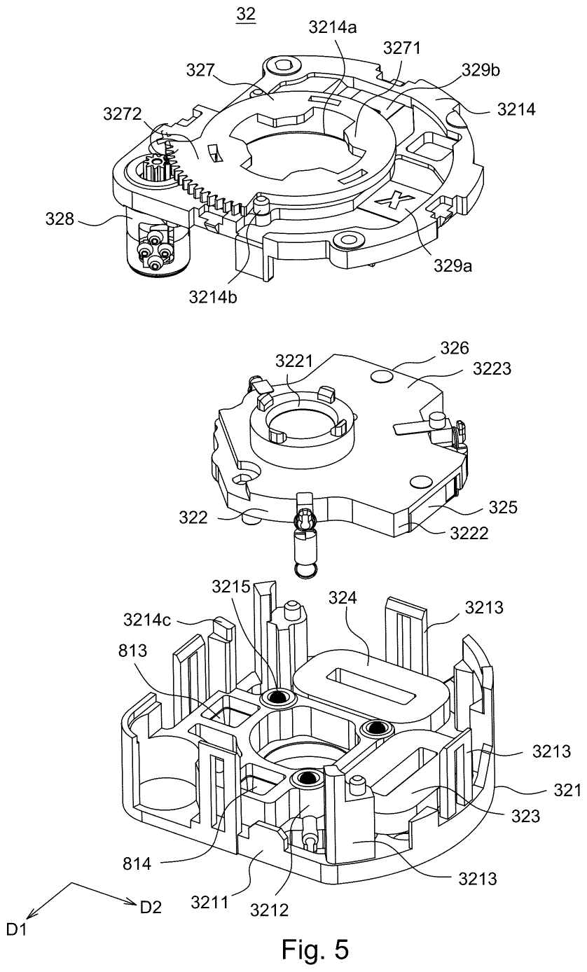

FIGS. 4 and 5 depict the structure of the first image stabilization assembly of an embodiment of the invention, wherein the first image stabilization assembly is taken as an example for descriptions because the second image stabilization assembly and the third image stabilization assembly have the same structure as the first image stabilization assembly. The first compensation assembly 32 includes a base 321, a movable platform 322, a first coil 323, a second coil 324, a first magnet 325, a second magnet 326, a limiting element 327, and a driving element 328.

The base 321 includes a bottom portion 3211, a raised structure 3212 disposed on the bottom portion 3211, a plurality of support portions 3213 erected vertically from the edge of the bottom portion 3211, and an upper cover 3214 disposed to cover the bottom portion 3211 and supported by the support portions 3213. The raised structure 3212 is provided with a plurality of balls 3215, and the movable platform 322 is disposed on the raised structure 3212 of the base 321 and is supported by the plurality of balls 3215. The movable platform 322 has a protruding lens mounting seat 3221 and two adjacent magnet mounting seats 3222 and 3223. The lens mounting seat 3221 is provided with four propping protrusions 3224.

The first lens 31 is disposed on the lens mounting seat 3221 of the movable platform 322, and the first magnet 325 and the second magnet 326 are disposed on the magnet mounting seats 3222 and 3223 respectively. The first coil 323 and the second coil 324 are disposed on the bottom portion 3211 and located at two adjacent sides of the raised structure 3212.

When current passes through the first coil 323 and the second coil 324, the magnetic fields generated by the current in the first coil 323 and the second coil 324 interact with the magnetic fields of the first magnet 325 and the second magnet 326 to generate attraction forces or repulsive forces therebetween, causing the movable platform 322 to move on the base 321 along the first direction D1 and/or the second direction D2. Accordingly, the first lens 31 mounted on the movable platform 322 is moved along the first direction D1 and/or the second direction D2. The first direction D1 and the second direction D2 are orthogonal to each other, and both the first direction D1 and the second direction D2 are perpendicular to the first optical axis 311.

The first coil 323 and the second coil 324 are electrically connected to the control module 50. The control module 50 controls the current values of the first coil 323 and the second coil 324 in accordance with the movement distance required by the first lens 31 for compensation.

The first compensation assembly 32 further includes a first position sensor 329a and a second position sensor 329b. Both the first position sensor 329a and the second position sensor 329b are electrically connected to the control module 50. The control module 50 detects the position of the first magnet 325 by using the first position sensor 329a and/or detects the position of the second magnet 326 by using the second position sensor 329b. The first position sensor 329a and the second position sensor 329b transmit detection signals to the control module 50. The control module 50 controls the current flowing through the first coil 323 and/or the second coil 324 in accordance with the detection signals.

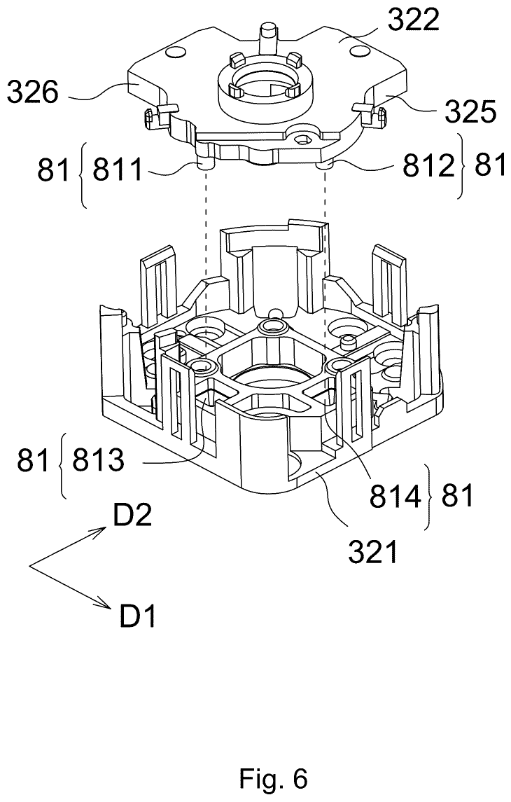

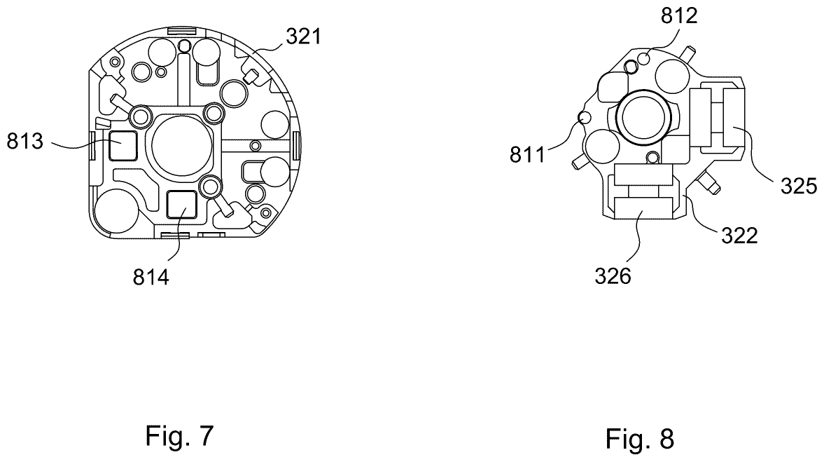

Referring to FIGS. 6, 7, and 8, the optical ranging device 1 with image stabilization function of this embodiment further includes a limiting mechanism. The limiting mechanism includes a first limiting module 81 and a second limiting module. The first limiting module 81 is coupled to the first compensation assembly 32. The first limiting module 81 includes a first limiting pin 811, a second limiting pin 812, a first limiting hole 813, and a second limiting hole 814. The first limiting pin 811 and the second limiting pin 812 are disposed on the surface of the movable platform 322 near the base 321. The first limiting hole 813 and the second limiting hole 814 are formed on another surface of the base 321 near the movable platform 322. The first limiting pin 811 extends into the first limiting hole 813, and the second limiting pin 812 extends into the second limiting hole 814. When the movable platform 322 is moved with respect to the base 321, the first limiting pin 811 is propped against the inner wall of the first limiting hole 813 in the first direction D1 thereby limiting the movement of the movable platform 322 in the first direction D1, and the second limiting pin 812 is propped against the inner wall of the second limiting hole 814 in the second direction D2 thereby limiting the movement of the movable platform 322 in the second direction D2. Further, the range of travel of the movable platform 322 in the first direction D1 is the same as that in the second direction D2. In this embodiment, the maximum total travel distance (i.e., displacement) of the movable platform 322 is ±0.8 mm. In further explanation, the same sensitivity described above refers to synchronous movement. The allowable error for synchronous movement is +0.1 degrees. Within the allowable error range, it can be considered as synchronous movement. The allowable error range will be different if the movement distance is calculated based on different zoom ratios. For a 6× optical system, 0.1 degrees are corresponded to a lens movement distance of approximately 0.17 mm. For a 10× optical system, 0.1 degrees are corresponded to a lens movement distance of approximately 0.07 mm. It is found that

$$\frac{total travel distance - lens movement distance}{total travel distance} \times zoom ratio$$

is approximately 11±25%. For a 6× optical system,

$$\frac{0.8 - 0.17}{0.8} \times \frac{1}{6} = 13 \% .$$

For a 10× optical system,

$$\frac{0.8 - 0.07}{0.8} \times \frac{1}{10} = 9 \% .$$

Field of view (FOV) is also described. The maximum total travel distance of the movable platform 322 is approximately +0.8 mm. It can be adapted to different ranges of entrance pupil diameter, field of view, etc. Referring to FIG. 1, the entrance pupil diameter of the objective lens end 611 of the telescope assembly 60 and the entrance pupil diameter of the receiving assembly 20 are not necessarily the same. The field of view of the objective lens end 611 of the telescope assembly 60 and the field of view of the receiving assembly 20 are not necessarily the same, either. If the movable platform 322 is provided with a sufficient travel distance, then the requirements of different entrance pupil diameters, different field of view, and an allowable error of ±0.1 degrees for synchronous movement can be simultaneously met. The structure of the second limit module is the same as that of the first limit module 81 and therefore the descriptions thereof are omitted.

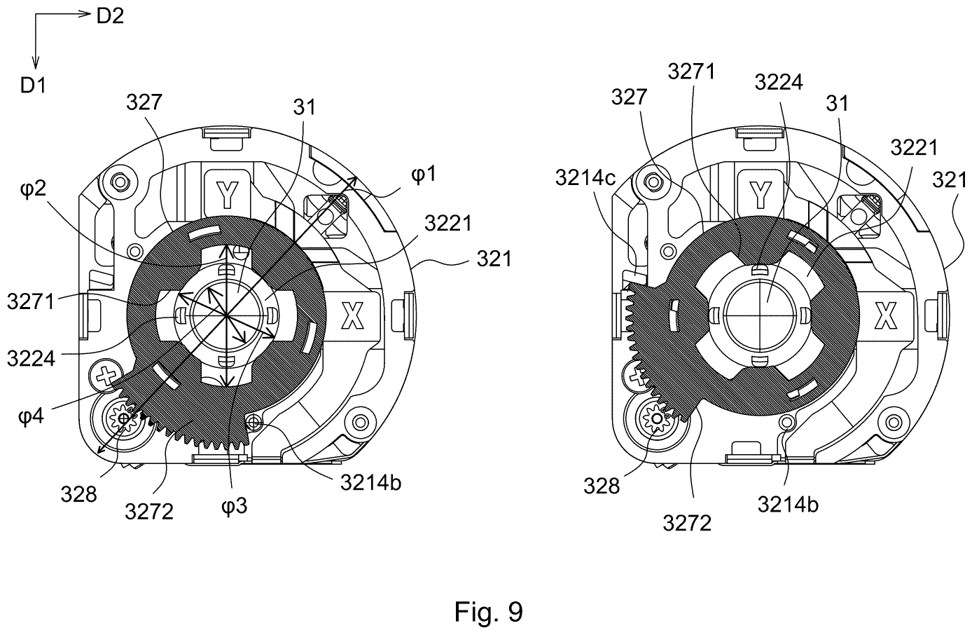

FIG. 9 shows the state of a limiting element 327 in the locking position and the releasing position, wherein the limiting element 327 is disposed on the upper cover 3214 of the base 321. The upper cover 3214 has an opening 3214a. The lens mounting seat 3221 of the movable platform 322 protrudes from the upper cover 3214 through the opening 3214a. The limiting element 327 is rotatably disposed on the upper cover 3214. The limiting element 327 is annular, with four propping teeth 3271 provided on its inner periphery and a driving tooth 3272 provided on its outer periphery. The driving tooth 3272 meshes with the gear on the output shaft of the driving element 328. By this arrangement, the driving element 328 can drive the limiting element 327 to move within an unlocking stroke which is the travel distance of the limiting element from the locking position to the releasing position. The upper cover 3214 has a limiting post 3214b and 3214c on each side of the driving tooth 3272 to limit the rotation stroke of the limiting element 327. When the driving tooth 3272 of the limiting element 327 is propped against the limiting post 3214b or 3214c, the limiting element 327 is correspondingly in the locking position or the releasing position.

When the limiting element 327 is rotated to the locking position as shown in the right part of FIG. 9, the propping teeth 3271 of the limiting element 327 are propped against the propping protrusions 3224. Under such circumstance, the movable platform 322 is restricted from movement by the limiting element 327, and the image stabilization function of the optical ranging device 1 is turned off. When the limiting element 327 is rotated to the releasing position as shown in the left part of FIG. 9, the propping teeth 3271 of the limiting element 327 are separated from the propping protrusions 3224. Under such circumstance, the movable platform 322 can be moved in the first direction D1 and the second direction D2, and the image stabilization function of the optical ranging device 1 is turned on.

The dimensions of each part of the first compensation assembly 32 satisfy any one of the following conditions (1)-(9) or any combination thereof:

$$9.25 mm \leq φ 1 \leq 11.9 mm ; \qquad ( 1 )$$

$$6.5 mm \leq φ 2 \leq 8.9 mm ; \qquad ( 2 )$$

$$4.2 mm \leq φ 3 \leq 6.4 mm ; \qquad ( 3 )$$

$$0.05 mm \leq ξ \leq 1.25 mm ; \qquad ( 4 )$$

$$0.25 ≦ ( ξmax / ( φ2max - φ4 ) ) ≦ 0.5 ; \qquad ( 5 )$$

$$0.475 ≦ ( ξmin / ( φ2min - φ3 ) ) ≦ 0.525 ; \qquad ( 6 )$$

$$0.5 ≦ ( φ3 / φ1 ) ≦ 0.7 ; \qquad ( 7 )$$

$$0.65 ≦ ( φ3 / φ2max ) ≦ 0.75 ; \qquad ( 8 )$$

$$0.495 ≦ ξmax / ( φ2max - φ2min ) ≦ 0.55 , \qquad ( 9 )$$

where φ1 is the diameter of the first compensation assembly 32, φ2 is an inner diameter of the limiting element 327 that is corresponded to the movable platform 322, φ3 is an outer diameter of the movable platform 322 that is corresponded to the limiting element 327, ξ is a gap between the limiting element 327 and the movable platform 322, φ2max is the maximum value of φ2, φ2min is the minimum value of φ2, ξmax is the maximum value of ξ, ξmin is the minimum value of ξ, φ4 is a diameter of the inner hole of the movable platform 322. The first lens 31 is disposed on the movable platform 322. Therefore, the diameter of the inner hole of the movable platform 322 is equal to the entrance pupil diameter of the first lens 31. If any one of the conditions (5)-(9) is satisfied, then the movable platform 322 can be moved in an allowable range when the limiting element 327 is in the releasing position. The allowable range of the movable platform 322 is also the motion distance of the first lens 31. When the limiting element 327 is in the locking position, the movable platform 322 can be properly fixed. It also relates to the tolerance of the limiting mechanism for installation of the optical ranging device 1 and the compatibility of the limiting mechanism with the overall size of the optical ranging device 1 (miniaturization).

The optical ranging device of the invention is provided with a first image stabilization module corresponding to the transmitting assembly and a second image stabilization module corresponding to the receiving assembly. When the user performs the ranging operation, in response to slight hand shaking, the first image stabilization module compensates for the movement of the optical path of the measurement beam of the transmitting assembly, and the second image stabilization module simultaneously compensates for the movement of the optical path of the reflection beam. By such arrangement, the measurement beam can be accurately projected to the measured object, and the reflection beam can be accurately received by the receiving assembly, thus capable of compensating for the hand shaking and accurately measuring the distance.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. An optical ranging device with image stabilization function for measuring a distance of an object, comprising:
a transmitting assembly configured to transmit a measurement beam wherein the measurement beam travels to the object and is reflected by the object to form a reflection beam;
a receiving assembly configured to receive the reflection beam;
a first image stabilization module comprising a first lens and a first compensation assembly wherein the first image stabilization module is disposed corresponding to the transmitting assembly, the first lens comprises a first optical axis, the measurement beam passes through the first lens, and the first compensation assembly is configured for driving the first lens to move with respect to the transmitting assembly or to be fixed in a first central position;
a limiting mechanism coupled to the first compensation assembly for restricting a travel distance of the first lens;
a motion sensor;
a control module electrically connected to the first compensation assembly and the motion sensor, and configured to control the first compensation assembly based on a detection of the motion sensor so that the first optical axis of the first lens is moved within the travel distance restricted by the limiting mechanism or is fixed in the first central position;
a second image stabilization module comprising a second lens and a second compensation assembly wherein the second image stabilization module is disposed corresponding to the receiving assembly, the second lens has a second optical axis, the reflection beam passes through the second lens, the second compensation assembly is configured for driving the second lens to move with respect to the receiving assembly or to be fixed in a second central position;
wherein the limiting mechanism is further coupled to the second compensation assembly for restricting a travel distance of the second lens;
wherein the control module is further configured to control the second compensation assembly based on a detection of the motion sensor so that the second optical axis of the second lens is synchronously moved along with the first optical axis of the first lens within the travel distance restricted by the limiting mechanism or is fixed in the second central position;
wherein the first compensation assembly comprises a driving element and a limiting element, and the driving element is configured for driving the limiting element to move within a stroke.

2. The optical ranging device as claimed in claim 1, further comprising:
a telescope assembly comprising an objective lens end, an eyepiece lens end and a telescope optical axis;
wherein the telescope assembly is disposed corresponding to the transmitting assembly;
wherein the telescope optical axis and the first optical axis coincide;
wherein the measurement beam passes through the telescope assembly and the first lens and reaches the object;
wherein the first compensation assembly drives the first lens to move with respect to the telescope assembly so that light emitted from the object can enters the telescope assembly and keeps forming images on the eyepiece lens end.

3. The optical ranging device as claimed in claim 1, further comprising:
a telescope assembly comprising an objective lens end, an eyepiece lens end and a telescope optical axis;
wherein the telescope assembly is disposed corresponding to the receiving assembly;
wherein the telescope optical axis and the second optical axis overlap;
wherein the reflection beam passes through the second lens and the telescope assembly and reaches the receiving assembly;
wherein the second compensation assembly drives the second lens to move with respect to the telescope assembly so that light emitted from the object can enters the telescope assembly and keeps forming images on the eyepiece lens end.

4. The optical ranging device as claimed in claim 1, further comprising:
a telescope assembly comprising an objective lens end, an eyepiece lens end and a telescope optical axis;
a third image stabilization assembly comprising a third lens and a third compensation assembly;
wherein the third lens comprises a third optical axis;
wherein the telescope optical axis and the third optical axis coincide;
wherein the third compensation assembly drives the third lens to move with respect to the telescope assembly so that light emitted from the object can enters the telescope assembly and keeps forming images on the eyepiece lens end.

5. The optical ranging device as claimed in claim 4, wherein:
the first lens is disposed on a first sectional plane which is perpendicular to the first optical axis;
the second lens is disposed on a second sectional plane which is perpendicular to the second optical axis;
the third lens is disposed on a third sectional plane which is perpendicular to the third optical axis;
the third sectional plane is parallel to the first sectional plane and the second sectional plane.

6. The optical ranging device as claimed in claim 4, wherein:
the third compensation assembly is electrically connected to the control module;
the control module is configured to control the third compensation assembly so that the third optical axis of the third lens, the first optical axis of the first lens, and the second optical axis of the second lens are moved synchronously.

7. The optical ranging device as claimed in claim 6, wherein an allowable error for synchronous movement of the first optical axis, the second optical axis and the third optical axis is ±0.1 degrees.

8. The optical ranging device as claimed in claim 1, wherein:
the first compensation assembly further comprises a base, a movable platform, a first coil and a first magnet;
the movable platform is movably disposed on the base;
the first lens is disposed on the movable platform;
the first coil is disposed on the base and is electrically connected to the control module;
the first magnet is disposed on the movable platform;
the first coil and the first magnet generate an electromagnetic interaction therebetween so that the movable platform is moved on the base in a first direction;
the first compensation assembly satisfies any one of the following conditions or any combination thereof:
$$0.25 ≦ ( ξmax / ( φ2max - φ4 ) ) ≦ 0.5 ;$$
$$0.475 ≦ ( ξmin / ( φ2min - φ3 ) ) ≦ 0 \text{.525} ;$$
$$0.5 ≦ ( φ3 / φ1 ) ≦ 0.7 ;$$
$$0.65 ≦ ( φ3 / φ2max ) ≦ 0 \text{.75} ;$$
$$0.495 ≦ ξmax / ( φ2max - φ2min ) ≦ 0.55 ,$$
where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

9. The optical ranging device as claimed in claim 8, wherein:
the first compensation assembly further comprises a second coil, a second magnet, a first position sensor and a second position sensor;
the second coil is disposed on the base;
the second magnet is disposed on the movable platform;
the second coil and the second magnet generate an electromagnetic interaction therebetween so that the movable platform is moved on the base in a second direction;
the second direction is orthogonal to the first direction;
the second coil is electrically connected to the control module;
the first optical axis is perpendicular to the first direction and the second direction;
the first position sensor and the second position sensor are electrically connected to the control module;
the control module controls a current flowing through the first coil and/or the second coil based on a position of the first magnet detected by the first position sensor and/or a position of the second magnet detected by the second position sensor.

10. The optical ranging device as claimed in claim 8, wherein the limiting mechanism restricts the movable platform to have the same range of travel in both the first and second directions.

11. The optical ranging device as claimed in claim 9, wherein:
the limiting mechanism comprises a first limiting module;
the first limiting module comprises a first limiting pin, a second limiting pin, a first limiting hole and a second limiting hole;
the first limiting pin and the second limiting pin are disposed on the movable platform;
the first limiting hole and the second limiting hole are formed on the base;
the first limiting pin is propped against an inner wall of the first limiting hole thereby limiting movement of the movable platform in the first direction;
the second limiting pin is propped against an inner wall of the second limiting hole thereby limiting movement of the movable platform in the second direction.

12. The optical ranging device as claimed in claim 9, wherein:
the limiting element is disposed on the base;
the stroke is a travel distance of the limiting element from a locking position to a releasing position;
the limiting element is propped against the movable platform to fix the movable platform at a center of the movable platform, when the limiting element is moved to the locking position;
the limiting element is separated from the movable platform and the movable platform is movable with respect to the base, when the limiting element is moved to the releasing position.

13. An optical ranging device with image stabilization function for measuring a distance of an object, comprising:
a transmitting assembly configured to transmit a measurement beam wherein the measurement beam travels to the object and is reflected by the object to form a reflection beam;
a receiving assembly configured to receive the reflection beam;
a first image stabilization module comprising a first lens and a first compensation assembly wherein the first image stabilization module is disposed corresponding to the transmitting assembly, the first lens comprises a first optical axis, the measurement beam passes through the first lens, and the first compensation assembly is configured for driving the first lens to move with respect to the transmitting assembly or to be fixed in a first central position;
a limiting mechanism coupled to the first compensation assembly for restricting a travel distance of the first lens;
a motion sensor;
a control module electrically connected to the first compensation assembly and the motion sensor, and configured to control the first compensation assembly based on a detection of the motion sensor so that the first optical axis of the first lens is moved within the travel distance restricted by the limiting mechanism or is fixed in the first central position;
a second image stabilization module comprising a second lens;
wherein the first compensation assembly comprises a driving element and a limiting element, and the driving element is configured for driving the limiting element to move within a stroke;
wherein the first optical axis of the first lens and the second optical axis of the second lens are moved at the same speed;
wherein the first lens is disposed on a first sectional plane which is perpendicular to the first optical axis;
wherein the second lens is disposed on a second sectional plane which is perpendicular to the second optical axis;
wherein the first sectional plane is parallel to or coincides with the second sectional plane.

14. The optical ranging device as claimed in claim 13, wherein:
the first compensation assembly further comprises a base, a movable platform, a first coil and a first magnet;
the movable platform is movably disposed on the base;
the first lens is disposed on the movable platform;
the first coil is disposed on the base and is electrically connected to the control module;
the first magnet is disposed on the movable platform;
the first coil and the first magnet generate an electromagnetic interaction therebetween so that the movable platform is moved on the base in a first direction;
the first compensation assembly satisfies any one of the following conditions or any combination thereof:
$$0.25 ≦ ( ξmax / ( φ2max - φ4 ) ) ≦ 0.5 ;$$
$$0.475 ≦ ( ξmin / ( φ2min - φ3 ) ) ≦ 0 \text{.525} ;$$
$$0.5 ≦ ( φ3 / φ1 ) ≦ 0.7 ;$$
$$0.65 ≦ ( φ3 / φ2max ) ≦ 0 \text{.75} ;$$
$$0.495 ≦ ξmax / ( φ2max - φ2min ) ≦ 0.55 ,$$
where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

15. The optical ranging device as claimed in claim 14, wherein:
the first compensation assembly further comprises a second coil, a second magnet, a first position sensor and a second position sensor;
the second coil is disposed on the base;
the second magnet is disposed on the movable platform;
the second coil and the second magnet generate an electromagnetic interaction therebetween so that the movable platform is moved on the base in a second direction;
the second direction is orthogonal to the first direction;
the second coil is electrically connected to the control module;
the first optical axis is perpendicular to the first direction and the second direction;
the first position sensor and the second position sensor are electrically connected to the control module;
the control module controls a current flowing through the first coil and/or the second coil based on a position of the first magnet detected by the first position sensor and/or a position of the second magnet detected by the second position sensor.

16. The optical ranging device as claimed in claim 14, wherein the limiting mechanism restricts the movable platform to have the same range of travel in both the first and second directions.

17. The optical ranging device as claimed in claim 15, wherein:
the limiting mechanism comprises a first limiting module;
the first limiting module comprises a first limiting pin, a second limiting pin, a first limiting hole and a second limiting hole;
the first limiting pin and the second limiting pin are disposed on the movable platform;
the first limiting hole and the second limiting hole are formed on the base;
the first limiting pin is propped against an inner wall of the first limiting hole thereby limiting movement of the movable platform in the first direction;
the second limiting pin is propped against an inner wall of the second limiting hole thereby limiting movement of the movable platform in the second direction.

18. The optical ranging device as claimed in claim 15, wherein:
the limiting element is disposed on the base;
the stroke is a travel distance of the limiting element from a locking position to a releasing position;
the limiting element is propped against the movable platform to fix the movable platform at a center of the movable platform, when the limiting element is moved to the locking position;
the limiting element is separated from the movable platform and the movable platform is movable with respect to the base, when the limiting element is moved to the releasing position.

19. An optical ranging device with image stabilization function for measuring a distance of an object, comprising:
a transmitting assembly configured to transmit a measurement beam wherein the measurement beam travels to the object and is reflected by the object to form a reflection beam;
a receiving assembly configured to receive the reflection beam;
a first image stabilization module comprising a first lens and a first compensation assembly wherein the first image stabilization module is disposed corresponding to the transmitting assembly, the first lens comprises a first optical axis, the measurement beam passes through the first lens, and the first compensation assembly is configured for driving the first lens to move with respect to the transmitting assembly or to be fixed in a first central position;
a limiting mechanism coupled to the first compensation assembly for restricting a travel distance of the first lens;
a motion sensor;
a control module electrically connected to the first compensation assembly and the motion sensor, and configured to control the first compensation assembly based on a detection of the motion sensor so that the first optical axis of the first lens is moved within the travel distance restricted by the limiting mechanism or is fixed in the first central position;
wherein the first compensation assembly comprises a driving element, a limiting element, a base, a movable platform, a first coil and a first magnet;
wherein the driving element is configured for driving the limiting element to move within a stroke;
wherein the movable platform is movably disposed on the base;
wherein the first lens is disposed on the movable platform;
wherein the first coil is disposed on the base and is electrically connected to the control module;
wherein the first magnet is disposed on the movable platform;
wherein the first coil and the first magnet generate an electromagnetic interaction therebetween so that the movable platform is moved on the base in a first direction;
wherein the first compensation assembly satisfies any one of the following conditions or any combination thereof:
$$0.25 ≦ ( ξmax / ( φ2max - φ4 ) ) ≦ 0.5 ;$$
$$0.475 ≦ ( ξmin / ( φ2min - φ3 ) ) ≦ 0 \text{.525} ;$$
$$0.5 ≦ ( φ3 / φ1 ) ≦ 0.7 ;$$
$$0.65 ≦ ( φ3 / φ2max ) ≦ 0 \text{.75} ;$$
$$0.495 ≦ ξmax / ( φ2max - φ2min ) ≦ 0.55 ,$$
where φ1 is a diameter of the first compensation assembly, φ2 is an inner diameter of the limiting element that is corresponded to the movable platform, φ3 is an outer diameter of the movable platform that is corresponded to the limiting element, ξ is a gap between the limiting element and the movable platform, φ2max is the maximum value of φ2, φ2min is the minimum value of φ2, ξmax is the maximum value of ξ, ξmin is the minimum value of ξ, φ4 is a diameter of the inner hole of the movable platform.

20. The optical ranging device as claimed in claim 19, wherein the first compensation assembly further satisfies any one of the following conditions or any combination thereof:
$$9.25 mm \leq φ1 \leq 11.9 mm ;$$
$$6.5 mm \leq φ2 \leq 8.9 mm ;$$
$$4.2 mm \leq φ3 \leq 6.4 mm ;$$
$$0.05 mm \leq ξ \leq 1.25 mm .$$
